(19) United States
(12) Patent Application Publication
(10) Pub. No.: US 2019/0372986 A1
(43) Pub. Date: Dec. 5, 2019

(54) INTERFACE APPARATUS AND METHOD

(71) Applicant: JAGUAR LAND ROVER LIMITED, COVENTRY, WARWICKSHIRE (GB)

(72) Inventor: HARPREET SINGH, Warwickshire (GB)

(21) Appl. No.: 16/461,586

(22) PCT Filed: Jan. 16, 2018
(86) PCT No.: PCT/EP2018/051000

§ 371 Date: May 16, 2019

(30) Foreign Application Priority Data
Jan. 17, 2017 (GB) 1700818.6

(51) Int. Cl. H04L 29/06; B60K 37/06; G06F 16/953

(52) U.S. Cl. CPC H04L 63/105; G01C 21/3664; G06F 16/953; B60K 37/06

(57) ABSTRACT

Embodiments of the present invention provide a human-machine interface method (300) for a vehicle, comprising monitoring (305) one or more occupants within the vehicle to identify an occupant request, determining (320) a source of the occupant request corresponding to one of the one or more occupants within the vehicle, determining (330) an authority level associated with the source of the occupant request, and composing (375, 380) an output in dependence on the authority level being greater than or equal to a predetermined authority level threshold.

### TECHNICAL FIELD

The present disclosure relates to an interface method and apparatus, and particularly, but not exclusively, to an interface apparatus and method for providing information to an occupant of a vehicle. Aspects of the invention relate to a human-machine interface method, a controller for a human-machine interface, a human-machine interface, a vehicle and computer software.

### BACKGROUND

During a journey in a vehicle, occupants of the vehicle often desire to know information about the journey. Some information is provided by road signs which may indicate, for example, a distance to facilities available along a current road such as services providing rest facilities, food etc. If an occupant wishes to know other information then they are required to actively find that information. For example, an occupant of the vehicle may use a portable computing device such as a smartphone to search for information. The information may include information about facilities, weather traffic conditions, etc. However, this relies on the occupant using the computing device within the vehicle, which some occupants wish to avoid, and this is also difficult for a driver of the vehicle.

It is an object of embodiments of the invention to at least mitigate one or more of the problems of the prior art.

### SUMMARY OF THE INVENTION

Aspects and embodiments of the invention provide a human-machine interface method, a controller for a human-machine interface, a human-machine interface, a vehicle and computer software as claimed in the appended claims.

According to an aspect of the present invention, there is provided a human-machine interface method for a vehicle, wherein an authority level associated with a source of an occupant request is determined, and an output is composed in dependence on the authority level being at least a predetermined authority level. Advantageously only occupant requests associated with a sufficient authority level are acted upon. In this way, erroneous occupant requests within a vehicle are ignored.

According to another aspect of the present invention, there is provided a human-machine interface method for a vehicle, the method comprising passively monitoring one or more occupants within the vehicle to identify an occupant request, determining a source of the occupant request corresponding to one of the one or more occupants within the vehicle, determining an authority level associated with the source of the occupant request, and composing an output in dependence on the authority level being greater than or equal to a predetermined authority level threshold.

According to another aspect of the present invention, there is provided a human-machine interface method for a vehicle, the method comprising monitoring one or more occupants within the vehicle to identify an occupant request, determining a source of the occupant request corresponding to one of the one or more occupants within the vehicle, determining an authority level associated with the source of the occupant request, and composing an output in dependence on the authority level being greater than or equal to a predetermined authority level threshold, wherein the monitoring may comprise one or both of listening to or visually observing the one or more occupants within the vehicle.

According to another aspect of the invention, there is provided a human-machine interface method for a vehicle, wherein the method comprises monitoring one or more occupants within the vehicle to identify an occupant request, determining a source of the occupant request corresponding to one of the one or more occupants within the vehicle, determining an authority level associated with the source of the occupant request and composing an output in dependence on the authority level being greater than or equal to a predetermined authority level threshold. Advantageously, only requests originating from the one or more occupants within the vehicle associated with an authority level greater than or equal to the predetermined authority level threshold are acted upon.

The authority level may be determined with respect to an authority level of the driver of the vehicle. Advantageously, the authority level of a request is determined relative to the driver's authority level as a reference authority level.

The method may comprise requesting a confirmation from an occupant having sufficient authority in dependence on the authority level being less than the predetermined authority level threshold. Advantageously, a request from an occupant without sufficient authority level may still be acted upon once confirmed.

The confirmation may comprise one or more of a physical input or an audible input. The physical input may be received at an input means or input device. The audible input may be received at an audio input means or an audio input device.

The physical input may comprise one or more of activation of a button, activation of a graphically displayed control, or a physical gesture.

The sufficient authority may comprise having an authority level greater than the predetermined authority level threshold. Advantageously, sufficient authority to confirm a request may be an authority level sufficient to have provided the request in a first instance.

The output may be composed in dependence on the confirmation. Advantageously, once confirmed the output is composed as normal.

The output may be not composed in dependence on the confirmation not being received. Advantageously, a request which is not confirmed does not lead to an output. Advantageously, occupants within the vehicle may not be encumbered with outputs relating to unconfirmed requests.

The output may comprise an offer to perform an action. The method may comprise receiving an indication from one of the one or more occupants within the vehicle of the offer being accepted, and initiating the action in dependence on the offer being accepted. Advantageously, the output may be considered by the one or more occupants. Advantageously, when the offer is acceptable, the occupants may provide such an indication whereupon the action is initiated in response.

A search associated with the request may be performed. The output may include an indication of information identified by the search. Advantageously, information identified by the search may be output to the one or more occupants.

The search may be performed in dependence on the request and information associated with the vehicle. Advantageously, the search may be at least partly based on the information associated with the vehicle. Thus the search may be context aware of the vehicle.

The information associated with the vehicle may comprise one or more of a location of the vehicle, a route associated with a navigation system of the vehicle, and conditions proximal to the vehicle. Advantageously, one or more attributes associated with the vehicle may form, at least partly, a basis for the search.

The search may be performed in dependence on historic information associated with one or more of the occupants of the vehicle. Advantageously, the search may utilise information associated with previous behaviour of the one or more occupants.

The historic information may be information about previous stops made by the one or more occupants. Advantageously, the search may take into account the previous stops by the one or more occupants.

The monitoring may comprise one or both of listening to or visually observing the one or more occupants within the vehicle. Advantageously, audible and visual behaviour of the one or more occupants may be taken into account.

The one or more occupants within the vehicle may be monitored passively. Advantageously, the monitoring may be non-intrusive.

The occupant request may comprise a spoken request.

According to a further aspect of the invention, there is provided a controller for a human-machine interface, wherein the controller comprises input means for receiving occupant data indicative of an occupant request originating from one or more occupants within a vehicle, control means arranged to determine an authority level associated with a source of the occupant request, the source of the occupant request corresponding to one of the one or more occupants within the vehicle, and to compose an output in dependence on the authority level being greater than or equal to a predetermined authority level threshold and output means for outputting data indicative of the composed output.

The controller as described above, wherein:
the input means is an electrical input for receiving electronic data;
the control means a control unit; and
the output means is an electrical output for outputting electronic data, which may represent information to be output to the one or more occupants of the vehicle.

The control means may compose the output by assembling a search request in dependence on the occupant data, outputting the search request to an internet search engine and receiving information identified by the search request from the search engine. Advantageously, information provided by the internet search engine relevant to the search request may be output to the one or more occupants of the vehicle.

The control means may compose the output in dependence on the information identified by the search request.

The control means may obtain information associated with the vehicle and assemble the search request in dependence on the information.

According to yet another aspect of the invention, there is provided a human-machine interface for a vehicle, wherein the human-machine interface comprises occupant monitoring means for monitoring one or more occupants within the vehicle to identify an occupant request and to output occupant data indicative the occupant request, control means arranged to receive the occupant data and to determine an authority level associated with a source of the occupant request, the source of the occupant request corresponding to one of the one or more occupants within the vehicle, wherein the control means is arranged to compose an output in dependence on the authority level being greater than or equal to a predetermined authority level threshold and output means for outputting the composed output to at least the one of the one or more occupants of the vehicle.

The human-machine interface described above, wherein:
the occupant monitoring means is one or more devices for determining behaviour or an output of the one or more occupants;
the control means is a control unit; and
the output means is one or more output devices.

The occupant monitoring means may comprise one or more audio monitoring devices. The occupant monitoring means may comprise visual monitoring devices. The output means may comprise one or more audio output devices and one or more visual output devices.

The control means may determine the authority level with respect to an authority level of the driver of the vehicle.

The occupant data may comprise information indicative of a category of occupant corresponding to the source of the occupant request.

The category of occupant may be selected from the group comprising adult and child.

The control means may determine an identity of an individual corresponding to the source of the occupant request and to determine the authority level corresponding to said individual.

The control means may cause the output means to output a request confirmation from an occupant having sufficient authority in dependence on the authority level being less than the predetermined authority level threshold.

The output composed by the control means may comprise an offer to perform an action. The control means may then receive, via the occupant monitoring means, an indication from the one of the one or more occupants within the vehicle of the offer being accepted and initiate the action in dependence on the offer being accepted.

The control means may assemble a search request in dependence on the occupant data, output the search request via an interface means to a communication means associated with the vehicle and receive from the communication means information identified by a search corresponding to the request performed by a search engine.

The control means may compose the output in dependence on the information identified by the search.

The control means may obtain information associated with the vehicle and to assemble the search request in dependence on the information.

The information may comprise one or more of a location of the vehicle, a route associated with a navigation system of the vehicle and conditions proximal to the vehicle.

The occupant monitoring means may comprise audio monitoring means for monitoring the speech of the one or more occupants of the vehicle.

The occupant monitoring means may comprise visual monitoring means for visually monitoring the one or more occupants of the vehicle.

The one or more occupants within the vehicle may be monitored passively.

According to an aspect of the present invention, there is provided computer software which, when executed by a computer, is arranged to perform a method according to an aspect of the invention. Optionally the computer software is stored on a computer-readable medium. The computer software may be tangibly stored on the computer-readable medium. The computer-readable may be non-transitory.

According to an aspect of the present invention, there is provided a vehicle arranged to perform a method according to aspect of the invention, or comprising a module or system according to an aspect of the invention.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying drawings, in which:

FIG. 1 shows a schematic representation of a vehicle comprising a human-machine interface according to an embodiment of the invention;

FIG. 2 is a schematic illustration of modules of a controller according to an embodiment of the invention;

FIG. 3 is a flowchart illustrating a method according to an embodiment of the invention; and

FIG. 4 is a vehicle according to an embodiment of the invention.

### DETAILED DESCRIPTION

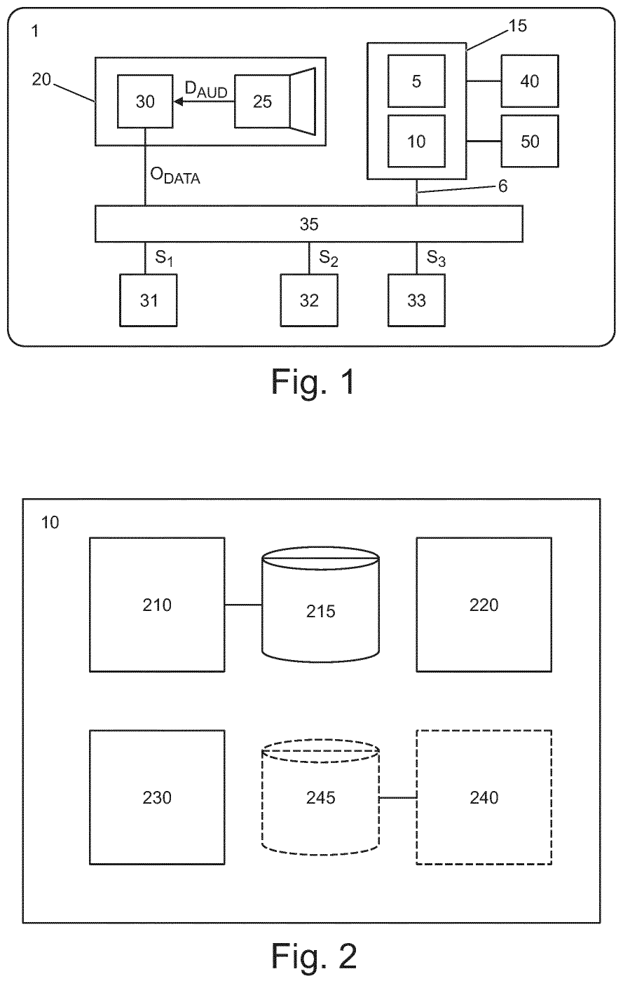

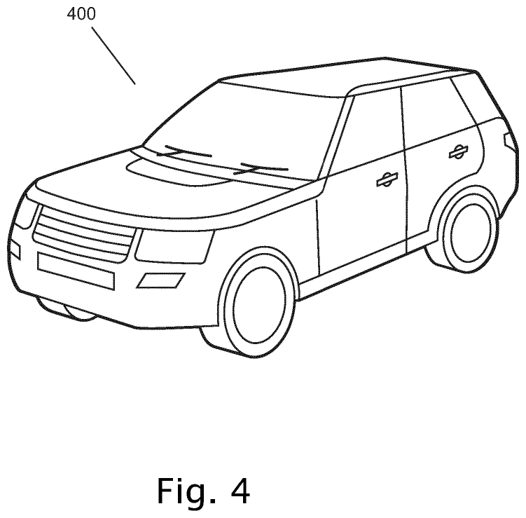

FIG. 1 illustrates a control means 10 according to an embodiment of the invention. The control means 10 may be a controller or control unit 10. In particular, some embodiments of the invention relate to controller 10 associated with a human-machine interface (HMI) 15. The controller 10, and HMI 15, is disposed in FIG. 1 in a vehicle 1 such as land-going vehicle, as illustrated in FIG. 4. It will be realised that embodiments of the invention are not limited in this respect and that the controller 10 may be useful in other vehicles, such as boats and aircraft.

The controller 10 comprises an electronic processor. The HMI 15 may further comprise a memory 5 such as a memory device 5. A set of computational instructions is stored on the memory device 5 which, when executed by the processor 10 cause the processor to implement a method(s) as described herein. The controller 10 comprises an input, such as an electrical input for receiving electronic data, which may in use receive data indicative of a status of one or more occupants of the vehicle 1, as will be explained. The controller 10 comprises an output, such as an electrical output for outputting electronic data, which may in use output data indicative of information to be output to one or more occupants of the vehicle 1, as will be explained.

The vehicle 1 comprises a passenger monitoring means 20 for determining a status of one or more occupants within the vehicle 1. The passenger monitoring means 20 may be an occupant monitoring system (OMS) 20. The OMS 20 comprises one or more devices 25 for determining behaviour or an output of the one or more occupants. In some embodiments, the one or more devices 25 are arranged to determine a spoken i.e. audible output of the one or more occupants, although in other embodiments the one or more devices 25 may alternatively or additionally visually determine the status or action of the one or more occupants. Thus in some embodiments the one or more devices may include one or more imaging devices or cameras. The OMS 20 is arranged to passively monitor the one or more occupants within the vehicle 1. That is, the OMS 20 performs on-going, non-intrusive, monitoring of the one or more occupants of the vehicle 1 which does not need to be initiated by the one or more occupants. As will be explained, the OMS 20 may determine one or more words or phrases spoken by the one or more occupants of the vehicle 1 without the one or more occupant actively triggering the determination, such as by providing a user input.

The OMS 20 may comprise an audio determining means 25 which may be in the form of one or more microphones 25. In the illustrated embodiment one microphone 25 is shown with it being realised that this is merely illustrative. Embodiments of the invention may comprise a plurality of microphones 25. The microphone 25 is configured to output audio data (D_{AUD}). The audio data is indicative of audio within at least a portion of an interior of the vehicle 1. In some embodiments, each of a plurality of microphones 25 is indicative of audio within a respective portion of the interior of the vehicle 1, which may correspond to a portion occupied by one occupant of the vehicle 1, although the portion may comprise a plurality of occupants, such as, for example, rear-seat occupants of the vehicle. Thus it may be possible to identify at least of the occupants from which the audio originates based on the microphone 25 outputting the audio data. The audio data D_{AUD} may comprise an identifier indicative of an identity of the microphone 25 from which the audio data originates.

The audio data D_{AUD} is received by a processor 30. The processor 30 may be an audio processor 30, although in embodiments of the invention also comprising one or imaging devices the processor 30 may be an audio-visual (AV) processor 30. It will also be appreciated that a second processor may be provided to process video data D_{VID}. The audio processor 30 may be an electronic processing device for analysing the received audio data D_{AUD}. The audio processor 30 executes software instructions implementing an audio analysis algorithm. The audio processor 30 is configured to analyse the audio data to identify spoken words within the audio data i.e. to distinguish spoken words from other sounds within the audio data. The audio processor 30 may then perform speech recognition on the audio corresponding to the spoken words to identify the words spoken by the occupant of the vehicle 1. The speech recognition may be performed against a data store of predetermined words i.e. a dictionary in order to identify spoken words from within the dictionary.

The audio processor 30 is arranged to passively monitor the speech of the one or more occupants within the vehicle 1. The audio processor 30 is arranged to, in use, identify an occupant request within the spoken words of the occupant. The audio processor 30 may also, in some embodiments, be arranged to determine identity information indicative of an identity of the occupant from which the speech originates. The identity information may be determined, in part, on the microphone from which the audio data is received i.e. corresponding to the location within the vehicle 1 of the occupant. Thus in some embodiments the identity information may correspond to the identifier associated with the microphone 25 from which the audio originated. However in some embodiments, the identity information may be determined by the audio processor based upon or more characteristics of the audio data, such as a frequency range of the spoken words i.e. corresponding to higher or lower pitched speech of the occupant. Thus the identity information may be indicative of one or both of a frequency range or frequency distribution of the speech.

The audio OMS 20 is arranged to output occupant data (O_{Data}). The occupant data is indicative of the recognised spoken words and, in some embodiments, the identity information indicative of the occupant of the vehicle 1 from which the spoken words originate.

The HMI 15 and the OMS 20 are communicatively coupled. The HMI 15 and the OMS 20 are communicatively coupled via a communication bus 35 of the vehicle 1. The communication bus 35 allows information to be exchanged between systems of the vehicle 1. The communication bus 35 may be implemented by CAN Bus or as an IP-based communication network, such as Ethernet, although it will be appreciated that other protocols may be used. Each of the HMI 15 and the OMS 20 may comprise an interface means for electrically coupling to the communication bus 25. The interface means may be a network interface corresponding to the communication bus 35, such as an Ethernet interface. When using such a bus 35, each system on the bus 35 may represent a network node having an associated ID or address, such as an IP address. Systems may communicate data to specific other systems via specifying one or more IP addresses to receive the data, or may broadcast or publish data to all other systems on the bus 35. It will be realised that other communication protocols may be used for the communication bus 35. The occupant data O_{Data} may be provided as one or more data packets published onto the communication bus 35 by the OMS 20 which may be received by the HMI 15.

The HMI 15 is operable to receive the occupant data O_{Data} from communication bus 35. The HMI 15 may also communicate information with other systems 31, 32, 33 of the vehicle 1 via the communication bus 35. For example, the one or more other systems 31, 32, 33 may comprise one or more of a vehicle navigation system 31, a traffic monitoring system 32 and a communication system 33 of the vehicle 1. The HMI 15 may request information from the one or more other systems 31, 32, 33 and may receive responses S₁, S₂, S₃ respectively from the one or more other systems 31, 32, 33 via the communication bus 35. For example, the HMI 15 may request location information indicative of a location of the vehicle 1 from the navigation system 31. The HMI 15 may communicate data with the communication system 33 which is arranged to wirelessly transmit the data to a server computer (not shown). The data may be indicative of a search request corresponding to an Internet search to be performed, wherein the server computer is arranged to perform the search in response to the received search request. Result(s) corresponding to the search request are then communicated from the server computer to the HMI 15 via the communication system 33 and bus 35. Alternatively the data may correspond to a desired action, wherein the server computer initiates the action in response to receiving the data.

The HMI 15 is coupled to one or more output means 40, 50 in the form of output devices 40, 50 arranged within the vehicle 1. The output means 40, 50 operably output information to one or more occupants of the vehicle 1. The information may be one or both of audibly and visually output to the one or more occupants. The one or more output means 40, 50 may comprise one or both of audio output means 40 and visual output means 50. The audio output means 40 may comprise one or more audio output devices 40, such as speakers, arranged within the vehicle 1. The visual output means 50 may comprise one or more visual display devices 50, such as display screens, arranged within the vehicle 1.

In some embodiments, each of a plurality of output means are 40, 50 directed to a respective occupant of the vehicle 1. For example, at least one of the visual output means 50 may be a display screen arranged to be viewable by the driver, such as mounted upon or within a dashboard of the vehicle 1 or forming a head-up display (HUD) of the vehicle 1. The vehicle 1 may comprise a plurality of display screens 50 each viewable by at least some of the occupants of the vehicle 1. For example, each rear seat passenger may be provided with a respective display screen 50 in addition to one or more display screens viewable by the driver. It will also be appreciated that audio output devices 40 within the vehicle 1 may be directed to specific occupants. The controller 10 of the HMI 15 is arranged in some embodiments to select from amongst the plurality of output means 40, 50 within the vehicle 1 to output information to a respective occupant. The respective occupant may correspond to the occupant from which the occupant data O_{Data} originated.

FIG. 1 illustrates, by way of example, the HMI 15 coupled to an audio output device 40 and a display screen 50. It will be appreciated that whilst only two output devices 40, 50 are illustrated that embodiments of the present invention are not limited in this respect. For example, the HMI 15 may be coupled to one or more of a plurality of display screens 50, audio output devices 40, such as speakers, and one or more haptic output devices for providing a physical sensory output.

FIG. 2 schematically illustrates modules 210, 220, 230 which may be operatively executed by the controller 10 of the HMI 15. It will be appreciated that the controller 10 may implement other modules besides those illustrated.

In some embodiments the controller 10 executes an authority determination module 210, an output composition module 220 and a request module 230. In some embodiments the authority determination is associated with a data store 215 which may store authority information. In some embodiments, the controller 10 executes a history module 240. The history module 240 may be associated with a further data store 245 which stores history information.

The authority determination module 210 is arranged to operably determine an authority level of an occupant of the vehicle associated with a received occupant request. The controller 10 is arranged to receive the occupant data O_{Data} and to provide the occupant data to the authority determination module 210.

As noted above, in some embodiments of the invention, the occupant data comprises identity information indicative of the occupant of the vehicle 1 from which the spoken words originate. The authority determination module operatively determines the authority level based on the identity information. As illustrated in FIG. 2, the authority determination module may be associated with a data store 215 which associates the identity information with an authority level. In some embodiments, based on seating positions of occupants within the vehicle, which may be determined based on image recognition of the occupants, the identifier associated with the microphone 25 from which the audio originated is associated with the authority level. Thus received audio is determined to originate from an occupant of the vehicle having an associated authority level based on the microphone identifier using the data store 215. In embodiments of the invention where the identity information comprises data indicative of one or both of a frequency range or frequency distribution of the occupant's speech, authority determination module 210 may determine the authority level based thereon.

The authority determination module 210 may determine the identity of the occupant based on the identity information and the data store 215. The occupant may be identified as one of a driver of the vehicle or a passenger of the vehicle. In some embodiments, each passenger of the vehicle 1 may be identified with respect to a seating position with the vehicle, such as front-seat passenger, rear seat passenger, or more specifically rear-right passenger, rear-left passenger etc., based in part on the identifier associated with the microphone 25. In some embodiments, the authority determination module 210 identifies the occupant as one of a plurality of occupant categories of occupant, which may comprise ‘adult’ and ‘child’. It will be realised that other categories of occupant may be envisaged. In some embodiments, data store 215 comprises profile information for a plurality of occupants of the vehicle indicative of one or more speech characteristics for each occupant of the vehicle 1, which enables the authority determination module 215 to specifically identify the occupant, such as ‘Garry’, ‘Doreen’, ‘Adam’ etc. Based on the identity the authority determination module 210 determines the authority level associated with the occupant.

The output composition module 220 is arranged to compose an output to the one or more occupants of the vehicle. In some embodiments, the output comprises an audible output which may be speech. Thus the output composition module 220 may comprise speech synthesis functionality to form spoken dialogue with the occupant of the vehicle. The dialogue may be formed on the basis of the occupant request, as will be explained.

The request module 230 is arranged to operatively determine the occupant request. The request module 230 is provided with the received occupant data O_{Data} indicative of the recognised spoken words. The request module 230 is arranged to determine the occupant request from amongst the spoken words. The occupant request may comprise a request for information to be searched for or a request for an action to be performed, as will be explained. The request module 230 may cause the controller 10 to communicate data indicative of the request with the communication system 33 and to receive a response thereto, which is provided to the output composition module 220 for composing the output based thereon.

The history module 240 is arranged to operatively store history information indicative of historical behaviour of the one or more occupants of the vehicle 1. The history information comprise information indicative of previous routes taken by the vehicle, stops made by the vehicle i.e. for rest or toilet stops, food stops i.e. types of location visited by the one or more occupants. It will be appreciated that other history information may be stored. The history information may be stored in the further data store 245, which may be referred to as a history data store 245.

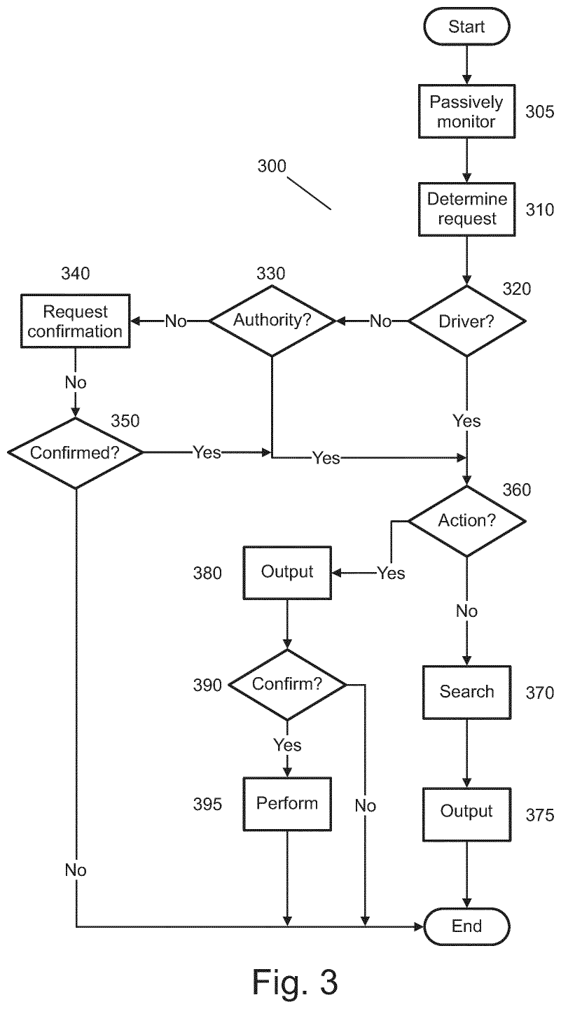

FIG. 3 illustrates a human-machine interface (HMI) method 300 according to an embodiment of the invention. The method 300 may be performed by the OMS 20 and the HMI 15.

The method 300 comprises a step 305 of passively monitoring one or more occupants within the vehicle 1. The passively monitoring 305 comprises one or both of passively listening or passively visually observing the one or more occupants within the vehicle 1. In some embodiments, step 310 comprises at least one microphone 25 outputting audio data D_{AUD} indicative of audio within at least a portion of an interior of the vehicle 1. The OMS 20 analyses the audio data to identify spoken words within the audio data, such as by performing speech recognition on the audio data. Step 305 may comprise determining the identify information indicative of the identity of the occupant from which the speech originates, as described above. In step 305 occupant data may be output by the OMS 20 to the HMI 15.

The method comprises a step 310 of determining an occupant request. Step 310 may be performed by the request module 230 operatively executed by the controller 10. The occupant request comprises one or more keywords indicative of the occupant's request. For example, the one or more keywords may comprise an indication of a need of the occupant, such as drink (“I'm thirsty”), coffee (“I wonder where I can get a coffee?”), rest, food, sleep, toilet etc. The one or more keywords may comprise an indication of an occupant's interest, such as flight time (“I wonder what time my flight is?”), news interest (“What is happening in the news?”). The one or more keywords may be indicative of a desire, such as concerning a time of arrival (“When will I get home?”), environment (“I hope that it isn't cold at home”). It will be appreciated that the bracketed text is merely provided as an example and that other keywords may be determined.

Step 320 comprises determining a source of the occupant request. The source of the occupant request corresponds to one of the one or more occupants within the vehicle 1. That is, step 320 comprises determining which of the vehicle's occupant(s) spoke the one or more keywords forming the occupant request. Step 320 may be performed by the authority determination module 210.

In particular, in some embodiments of step 320, it is determined whether the occupant request originated from the driver of the vehicle or other person designated as being in control of the vehicle. The person in control of the vehicle may be understood to mean the person with whom responsibility for the vehicle rests in the case of autonomous or semi-autonomous vehicles. The person driving the vehicle may be the person actively controlling the vehicle, such as operating a steering of the vehicle. Step 320 may be determined in dependence on the identity information indicative of the occupant from which the spoken words originate comprised in the occupant data O_{Data}. Step 320 may comprise determining from which of the plurality of microphones 25 output the audio data corresponding to the occupant request. If the microphone 25 corresponds to a seating position of the person in control of the vehicle or the driver of the vehicle, then step 320 may be determined in the affirmative. As explained above, the source of the occupant request may alternatively or additionally be performed in dependence on the data indicative of one or both of a frequency range or frequency distribution of the occupant's speech comprised within the occupant data received from the OMS 20.

If it is determined in step 320 that the occupant request originates from the person in control of the vehicle or the driver of the vehicle, the method 300 moves to step 360 as it is assumed that such persons have a sufficient authority level. However, if it is determined in step 320 that the occupant request originates from another person in the vehicle, the method 300 moves to step 330. Step 330 is thus performed if the source of the occupant request is not the person in control of the vehicle 1 or the driver of the vehicle.

Step 330 comprises determining an authority level associated with the source of the request. As noted above, the source of the request corresponds to the one of the occupants of the vehicle 1 from which the occupant request originated. Therefore in step 330 it is determined whether the source of the request is associated with a sufficient authority level to act upon the request. Step 330 may be performed by the authority determination module 210. As in step 320, the source of the request may be determined based upon the occupant data output by the OMS 20. In one embodiment the source of the occupant request may be determined in dependence on the identity information indicative of the occupant from which the spoken words originate comprised in the occupant data O_{Data}. Step 330 may comprise determining from which of a plurality of microphones 25 output the audio data corresponding to the occupant request. For example, a microphone associated with a front passenger seat of the vehicle 1 may be determined to correspond to an occupant of the vehicle having sufficient authority, whereas one or more microphones associated with rear seats of the vehicle 1 may be determined not to have sufficient authority. For example, children may be associated with the rear seats of the vehicle and thus be associated with a lower authority level. The authority level may be determined with respect to an authority level of the driver of the vehicle. That is, the person in the front passenger seat may be associated with an authority level equal to that of the driver. Step 330 may also be performed in dependence on the data indicative of one or both of a frequency range or frequency distribution of the occupant's speech comprised within the occupant data. Each occupant within the vehicle may be associated with a respective authority level and in step 330 the authority level associated with the source of the occupant request is compared against an authority level threshold. If the source of the occupant request is associated with an authority level equal to or greater than the authority level threshold, the method moves to step 360. If, however, the source of the occupant request is associated with an authority level less than the authority level threshold, the method moves to step 340.

In step 340 confirmation is requested from an occupant of the vehicle 1 having sufficient authority. Step 340 is performed in dependence on the authority level being less than the predetermined authority level in step 330, such as when the occupant request originates from a child within the vehicle 1. Step 340 may comprise outputting an indication that confirmation is requested. The indication may be output as one or both of an audible or visual indication within the vehicle. Step 340 may comprise the controller 10 of the HMI 15 controlling one or both of the audio output devices 40, such as speakers arranged within the vehicle 1, or the visual display devices 50, such as display screens arranged within the vehicle 1, to output the request for confirmation. Step 340 may be performed by the output composition module 220 which composes an output requesting confirmation responsive to a signal output by the authority determination module 210

Step 350 comprises determining whether the occupant request is confirmed by an occupant of the vehicle having sufficient authority. Step 350 may comprise receiving an input from an occupant being associated with an authority level equal to or greater than the authority level threshold, wherein the method moves to step 360. The user input may comprise receiving a physical input such as activation of a button, which may be physical, activation of a graphically displayed control, wherein the button or control is associated with an occupant having sufficient authority. Step 350 may comprise receiving an audible input, such as determination by the OMS 20 of a confirmation command such as “Yes” being spoken within the vehicle 1 by an occupant being associated with an authority level which is equal to or greater than the authority level threshold, or a physical gesture such as a wave of the hand by an occupant being associated with an authority level which is equal to or greater than the authority level threshold. It will be appreciated that other commands and gestures are useful.

If, in step 350 the occupant request is not confirmed i.e. the confirmation is negative, then the method 300 terminates. It will be appreciated that rather than the method 300 terminating, the method 300 may instead may return to step 305 where passive monitoring of the one or more occupants of the vehicle 1 is continued. However, if the occupant request is confirmed in step 350 then the method 300 moves to step 360.

In step 360 a type of occupant request is determined. Step 360 may comprise determining whether the occupant request is a request for information or a request for a desired action to be performed. The request for information may comprise an indication of information useful to the occupant. The action may be an activity which can be initiated by the HMI 15. If the occupant request is a request for information, the method 300 moves to step 370. If the occupant request is a request for an action, the method 300 moves to step 380.

In step 370 a search request is assembled based on the occupant data. Step 370 may be performed by the request module 230. In particular, the search request is assembled in dependence on the words or phrases spoken by the occupant of the vehicle 1. The search request may comprise one or more strings determined by the speech recognition. For example, the search request may comprise a search term such as “coffee”, “toilet”, “food”, etc. It will be appreciated that these terms are merely illustrative.

In some embodiments, step 370 comprises obtaining one or more items of information associated with the vehicle 1, wherein the search request is assembled based on the one or more items of information. The one or more items of information may be obtained from the one or more other systems 31, 32, 33, such as the vehicle navigation system 31 or the traffic monitoring system 32, although it will be realised that other systems may be utilised. For example, in one embodiment location information indicative of the vehicle's location or route information indicative of a route to be followed by the vehicle 1 may be obtained from the navigation system 31. In one embodiment, information indicative of conditions proximal to the vehicle such as weather or traffic conditions may be obtained. The one or more items of information may be used to narrow the search request, for example by geographically restricting a scope of the search request. For example one or both of the location information and route information may be included in the search request, such that the search is performed with respect to the location information or route information. In some embodiments, step 370 comprises obtaining historic information associated with one or more of the occupants of the vehicle, such as information about previous stops made by the one or more occupants. The historic information may be obtained as history information which, as noted above, may be stored in the history data store 245.

Step 370 comprises outputting the search request. The search request may be output to an Internet search engine such as hosted by or communicative with the server computer with which the communication system 33 is communicative. Step 370 may further comprise receiving information identified by the search from the search engine. In other words, the search result(s) are received in step 370. The search results may comprise, for example, information indicative of one or more locations relevant to the one or more strings in the search request. For example, step 370 may comprise receiving an indication of a coffee outlet proximal to the vehicle's location, or proximal to the vehicle's route.

Step 375 comprises composing an output based on the information identified by the search i.e. the search results received in step 370. The output may comprise a recommendation based on the search request, such as a recommendation of the coffee outlet identified in step 370 from the search results. Thus, as a result, the one or more occupants of the vehicle 1 are provided with relevant information, without the information being specifically requested, provided that the occupant request originates from an occupant having sufficient authority.

Returning to step 360, if the occupant request was determined to be a request for an action, the method 300 moves to step 380 wherein an indication that confirmation of the action to be performed is requested. The action may be an action external to the vehicle, such as turning on or off heating of the occupant's home. The indication may be output one or both of audibly or visually within the vehicle. Step 380 may comprise the controller 10 of the HMI 15 controlling one or both of the audio output devices 40, such as speakers arranged within the vehicle 1, or the visual display devices 50, such as display screens arranged within the vehicle 1, to output the request for confirmation of the action. Step 380 may be performed by the output composition module 220 which composes request for confirmation. If confirmation is not provided, then the method 300 terminates. It will be appreciated that rather than the method 300 terminating, the method 300 may instead may return to step 305 where passive monitoring of the one or more occupants of the vehicle 1 is continued. However, if the confirmation is provided in step 380 then the method 300 moves to step 390.

In step 390 an action request is assembled based on the occupant data. Step 390 may be initiated and performed 395 by the request module 230. In particular, the action request is assembled in dependence on the words or phrases spoken by the occupant of the vehicle 1. The action request may comprise one or more strings determined by the speech recognition. For example, the action request may comprise one or both of a subject and an action, such as the subjects “heating”, “water”, “oven”, etc., and the action “on”, “off” which may be performed with respect to the subject. It will be appreciated that these terms are merely illustrative.

The controller 10 may communicate data indicative of the action request with the communication system 33 which, as noted above, is arranged to wirelessly transmit the data to the server computer. The server computer is arranged to operably initiate the action in response to receiving the data. Thus, as a result, the one or more occupants of the vehicle 1 are able to cause the action to be performed, without the action being specifically requested, provided that the occupant request originates from an occupant having sufficient authority.

FIG. 4 illustrates a vehicle 400 according to an embodiment of the invention. The vehicle 400 is a land-going vehicle, although it will be appreciated that other vehicles may be envisaged such as watercraft and aircraft. The vehicle 400 comprises a human-machine-interface according to an aspect of the present invention, such as illustrated in FIG. 1.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A controller for a human-machine interface, the controller comprising:
an input for receiving occupant data indicative of an occupant request originating from one or more occupants within a vehicle, said occupant request identified by monitoring, by one or both of listening to and visually observing, one or more occupants within the vehicle;
a controller arranged to determine an authority level associated with a source of the occupant request, the source of the occupant request corresponding to one of the one or more occupants within the vehicle, the controller further arranged to compose an output based on the authority level being greater than or equal to a predetermined authority level threshold; and
an output for outputting data indicative of the composed output, wherein the controller is arranged to compose the output by assembling a search request based on the occupant data, outputting the search request to an Internet search engine, and receiving information identified by the search request from the search engine.

2. (canceled)

3. (canceled)

4. The controller of claim 1, wherein the control means is arranged to compose the output based on the information identified by the search request.

5. The controller of claim 1, wherein the controller is further arranged to obtain information associated with the vehicle and to assemble the search request based on the information.

6. A human-machine interface method for a vehicle, the method comprising:
monitoring, by one or both of listening to and visually observing, one or more occupants within the vehicle to identify an occupant request;
determining a source of the occupant request corresponding to one of the one or more occupants within the vehicle;
determining an authority level associated with the source of the occupant request; and
composing an output based on the authority level being greater than or equal to a predetermined authority level threshold, wherein the composing includes assembling a search request based on the occupant data, outputting the search request to an Internet search engine, and receiving information identified by the search request from the search engine.

7. The method of claim 6, wherein the authority level is determined with respect to an authority level of the driver of the vehicle, the method further comprising requesting a confirmation from an occupant having sufficient authority based on the authority level being less than the predetermined authority level threshold.

8. (canceled)

9. (canceled)

10. (canceled)

11. (canceled)

12. The method of claim 6, wherein the output comprises an offer to perform an action, the method further comprising:
receiving an indication from the one of the one or more occupants within the vehicle of the offer being accepted; and
initiating the action based on the offer being accepted.

13. The method of claim 6, further comprising performing a search associated with the request, and wherein the output includes an indication of information identified by the search.

14. (canceled)

15. (canceled)

16. The method of claim 13, wherein the search is performed based on historic information associated with one or more of the occupants of the vehicle.

17. (canceled)

18. (canceled)

19. (canceled)

20. A human-machine interface for a vehicle, comprising:
an occupant monitor for monitoring one or more occupants by one or both of listening to and visually observing said occupants within the vehicle to identify an occupant request and to output occupant data indicative thereof;
a controller arranged to receive the occupant data and to determine an authority level associated with a source of the occupant request, the source of the occupant request corresponding to one of the one or more occupants within the vehicle, wherein the controller is further arranged to compose an output based on the authority level being greater than or equal to a predetermined authority level threshold; and
an output for outputting the composed output to at least the one of the one or more occupants of the vehicle, wherein the controller is further arranged to compose the output by assembling a search request based on the occupant data, outputting the search request to an Internet search engine, and receiving information identified by the search request from the search engine.

21. (canceled)

22. The human-machine interface of claim 20, wherein the controller is further arranged to determine the authority level with respect to an authority level of the driver of the vehicle.

23. The human-machine interface of claim 22, wherein:
the occupant data comprises information indicative of a category of occupant corresponding to the source of the occupant request, and
the controller is further arranged to determine the authority level based on the category of occupant.

24. (canceled)

25. The human-machine interface of claim 22, wherein the controller is further arranged to determine an identity of an individual corresponding to the source of the occupant request and to determine the authority level corresponding to said individual.

26. The human-machine interface of claim 22, wherein the control means is further arranged to cause the output to output a request for confirmation from an occupant having sufficient authority based on the authority level being less than the predetermined authority level threshold.

27. The human-machine interface of claim 20, wherein the output composed by the controller comprises an offer to perform an action, the controller being further arranged to receive, via the occupant monitor, an indication from the one of the one or more occupants within the vehicle of the offer being accepted and to initiate the action based on the offer being accepted.

28. The human-machine interface of claim 20, wherein the controller is further arranged to assemble a search request based on the occupant data, to output the search request via an interface to a communication means associated with the vehicle and to receive from the communication means information identified by a search corresponding to the request performed by a search engine.

29. The human-machine interface of claim 28, wherein the controller is further arranged to compose the output based on the information identified by the search, wherein the controller is further arranged to obtain information associated with the vehicle and to assemble the search request based on the information.

30. (canceled)

31. (canceled)

32. (canceled)

33. (canceled)

34. A vehicle comprising a human-machine interface according to claim 20.

35. Computer software which, when executed by a computer, is arranged to perform a method according to claim 6.

36. The computer software of claim 35 tangibly stored on a computer readable medium.

37. (canceled)
